(19) United States
(12) Patent Application Publication
(10) Pub. No.: US 2025/0211901 A1
(43) Pub. Date: Jun. 26, 2025

(54) SOUND SYSTEM AND ELECTRONIC DEVICE WITH IMPROVED VIBRATION COMPENSATION

(71) Applicant: Sound Solutions International (Zhenjiang) Co., Ltd., Zhenjiang City (CN)

(72) Inventors: Matthias Possl, Vienna (AT); Friedrich Reining, Vienna (AT); Gergo Laszlo Gottlieb, Vienna (AT); Mario Schwarz, Vienna (AT)

(21) Appl. No.: 18/989,817

(22) Filed: Dec. 20, 2024

(30) Foreign Application Priority Data
Dec. 22, 2023 (AT) A 51050/2023

(51) Int. Cl. H04R 3/04; H04R 1/02; H04R 9/06; H04R 29/00

(52) U.S. Cl. CPC H04R 3/04; H04R 1/025; H04R 9/06; H04R 29/001; H04R 2400/11; H04R 2430/01

(57) ABSTRACT

A sound system (1, 1a . . . 1f) is disclosed, which comprises a speaker (2), an actuator (8) and coupling means (16) for mechanically coupling the actuator (8) to the speaker (2). The sound system (1, 1a . . . 1f) further comprises a signal influencing circuit (17, 17a . . . 17d) being designed to feed a first electric signal (SPS) to the speaker (2) for moving a speaker membrane (3) along a first axis (A1, A1′) and to feed a second electric signal (ACS) to the actuator (8) for moving a movable mass (12) along a displaced second axis (A2) based on an audio signal (AUD). The signal influencing circuit (17, 17a . . . 17d) is designed to vary an amplification (G) of the second electric signal (ACS) over a frequency range of the sound system (1, 1a . . . 1f) and/or to set a phase shift (P) between the first electric signal (SPS) and the second electric signal (ACS), which is non-equal to 0° and 180° in at least a part of the frequency range of the sound system (1, 1a . . . 1f). Furthermore, an electronic device (22a . . . 22c) with such a sound system (1, 1a . . . 1f) is disclosed.

### PRIORITY

This patent application claims priority from Austrian patent application No. A 51050/2023, filed Dec. 22, 2023, entitled “Sound System and Electronic Device with Improved Vibration Compensation,” the disclosure of which is incorporated herein, in its entirety, by reference.

### BACKGROUND

The invention relates to a sound system, which comprises a speaker, an actuator and coupling means for mechanically coupling the actuator to the speaker. The speaker has a membrane and a speaker motor coupled thereto, wherein the speaker motor is designed for moving the membrane along a first axis. The actuator has a moving mass and an actuator motor coupled thereto, wherein the actuator motor is designed for moving the moving mass along a second axis and wherein the second axis is displaced from the first axis. Moreover, the invention relates to an electronic device, which comprises a sound system of the above kind. The sound system is built into a housing and/or to a frame of the electronic device, wherein the coupling means for mechanically coupling the actuator to the speaker are formed at least partially by said housing and/or frame.

A sound system and an electronic device of the aforementioned kinds are generally known in prior art. In common designs, a vibration caused by the speaker motor of the speaker also induces a vibration into an electronic device, which the speaker is built into, based on the actio-reactio principle. Because these vibrations are unwanted in some applications, a vibration compensation for the above devices has been proposed. For example, a moving mass of an actuator motor is moved in antiphase with a movement of the speaker motor. However, the vibration compensation is done just up to a certain degree, and still some unwanted vibrations remain in common designs what can cause rattling of movable elements of the sound system or the electronic device like of buttons and so on.

### SUMMARY OF THE INVENTION

Accordingly, it is an object of the invention to overcome the drawbacks of the prior art and to provide an improved sound system and an improved electronic device. In particular, vibration compensation shall be improved and rattling of movable elements of the sound system or electronic device shall be avoided or at least be reduced.

The problem of the invention is solved by a sound system as defined in the opening paragraph, wherein the sound system further comprises a signal influencing circuit,
which has an audio input, a speaker output, an actuator output, a first signal path from the audio input to the speaker output and a second signal path from the audio input to the actuator output,
   which is designed to feed a first electric signal to the speaker motor via the speaker output and a second electric signal to the actuator motor via the actuator output based on an audio signal received at the audio input, and
   which is designed to vary an amplification (synonymously “gain”) of the second electric signal over a frequency range of the sound system and/or to set a phase shift φ between the first electric signal and the second electric signal, which phase shift φ is non-equal to 0° and 180° (i.e. 0°<Ω<180° and 180°<φ<360°) in at least a part of the frequency range of the sound system.

A method of operating the aforementioned sound system accordingly can comprise the steps of:
feeding a first electric signal to the speaker motor via the speaker output and feeding a second electric signal to the actuator motor via the actuator output based on an audio signal received at the audio input, and
varying an amplification of the second electric signal over a frequency range of the sound system and/or setting a phase shift between the first electric signal and the second electric signal, which phase shift is non-equal to 0° and 180° in at least a part of the frequency range of the sound system.

The problem of the invention is also solved by an electronic device, which comprises a sound system of the above kind, wherein the sound system is built into a housing and/or to a frame of the electronic device and wherein the coupling means for mechanically coupling the actuator to the speaker are formed at least partially by said housing and/or frame.

By use of the proposed measures, the drawbacks of the prior art are overcome. By setting an appropriate amplification and/or an appropriate phase shift (other than in-phase or antiphase) the vibration compensation can be improved for sound systems where the first axis, along which the membrane of the speaker is moved, is displaced from the second axis, along which the moving mass is moved.

For example the signal influencing circuit in an operating setting can be set in a way that, in at least a part of the frequency range of the sound system, an amplitude of a mechanical oscillation at a particular point of the housing and/or frame of the electronic device is below 50% of an amplitude of a mechanical oscillation at said particular point of the housing and/or frame in a reference setting where the actuator is switched off. A method of tuning a signal influencing circuit of a sound system accordingly can comprise the step of setting the signal influencing circuit in an operating setting in a way that, in at least a part of the frequency range of the sound system, an amplitude of a mechanical oscillation at a particular point of the housing and/or frame of the electronic device is below 50% of an amplitude of a mechanical oscillation at said particular point of the housing and/or frame in a reference setting where the actuator is switched off.

By the proposed measures, the sound system (strictly speaking its signal influencing circuit) can be tuned in a way that a vibration at particular points of the housing and/or frame of the electronic device is substantially reduced. Preferably, these points are located at movable elements (e.g. buttons), which otherwise would undesirably rattle or make other unwanted noise. For this purpose, during a tuning process, the amplification and/or the phase shift is varied until appropriate values have been found.

In an alternative embodiment, the signal influencing circuit in an operating setting is set in a way that, in at least a part of the frequency range of the sound system, a) a maximum amplitude or b) an average amplitude of a mechanical oscillation of the housing and/or frame of the electronic device in case a) is below 50% of a maximum amplitude or in case b) is below 50% of an average amplitude of a mechanical oscillation of the housing and/or frame in a reference setting where the actuator is switched off. An alternative method of tuning a signal influencing circuit of a sound system accordingly can comprise the step of setting the signal influencing circuit in an operating setting in a way that, in at least a part of the frequency range of the sound system, a) a maximum amplitude or b) an average amplitude of a mechanical oscillation of the housing and/or frame of the electronic device in case a) is below 50% of a maximum amplitude or in case b) is below 50% of an average amplitude of a mechanical oscillation of the housing and/or frame in a reference setting where the actuator is switched off.

Here, the sound system or its signal influencing circuit respectively can be tuned in a way that a vibration of the whole housing and/or frame of the electronic device is substantially reduced. Again, during a tuning process, the amplification and/or the phase shift is varied until appropriate values have been found. Tuning can be done in a way that a maximum amplitude of the housing and/or frame is substantially reduced (case a) or that an average amplitude of a mechanical oscillation of the housing and/or frame is substantially reduced (case b).

Preferably the above conditions are true in a steady state of the sound system, i.e. in a steady state of oscillations of the speaker and the actuator. Moreover, the above conditions particularly are true for harmonic or sinusoidal sound signals at the audio input.

The reference setting may also be termed as “initial setting” or “default setting”. In general, the test can be performed by switching off the second signal path, by cutting off the actuator from the signal influencing circuit or by setting zero gain in the matching filter or in an additional (power saving) filter of the signal influencing circuit.

One should note in the above context that the point, at which the maximum amplitude is measured in the operating setting, is not necessarily the point, at which the maximum amplitude is measured in the reference setting. Instead, a maximum amplitude can appear at different locations in the operating setting and the reference setting. For example, a mechanical oscillation of the housing and/or frame or points thereof generally can be measured with a laser during the tuning procedure.

Generally, the frequency range of the sound system can reach from 20 Hz to 20 kHz. In this way, the frequency range of sound audible by humans is covered.

The coupling means for mechanically coupling the actuator to the speaker can be provided by a dedicated elastic element between the actuator and the speaker, for example by a bar or plate made of metal and/or plastic. However, the coupling means can also be formed by the housing and/or frame of the electronic device, which the speaker and the actuator are built into. Nevertheless, it should be noted in this context that the use of the housing and/or frame as a coupling between the actuator and the speaker does not exclude the use of a dedicated elastic element between the actuator and the speaker. In such a case, the coupling means are formed by both said elastic element and the housing and/or frame of the electronic device.

Advantageously, the coupling means for mechanically coupling the actuator to the speaker are formed by an elastic element with a natural resonance>1 kHz. The proposed frequency range provides sufficient coupling between the actuator and the speaker for housings of common electronic devices, which housings or elements thereof basically rattle above said frequency without vibration compensation.

The electronic device, for example, may be a mobile phone, a tablet computer or a laptop computer.

Generally an “actuator” transforms electrical power into movement and force. In contrast, a “speaker” transforms electrical power into sound. For the concerns of this disclosure, the actuator motor is not designed for moving a membrane along the second axis. In other words, the speaker is designed to transform electrical current into sound pressure, whereas actuator is designed to transform an electrical current into a movement of a mass without dedicated or pronounced sound generation. Generation of sound in view of the actuator is solely a side effect. In particular, an average sound pressure level of the speaker measured in an orthogonal distance of 10 cm from a sound emanating surface of the membrane can be at least 50 dB_SPL and an average sound pressure level of the actuator measured at the same directional distance can be at most 20 dB_SPL in the same frequency range.

Generally, the above devices may also be intended for generation of vibration for haptic feedback.

The electronic device may comprise a frame and/or a housing. A housing encompasses a volume, which is more or less closed. A housing shall protect the interior parts from exterior influences like dust, humidity and so on. In some cases, a housing is hermetically sealed. In contrast, a frame does not have a pronounced sealing function but is intended to hold together parts of the electronic device.

Similar considerations can be made for the speaker, the actuator and the sound system, which each can comprise a frame and/or a housing having the aforementioned characteristics.

Generally, the signal influencing circuit can comprise a (digital) matching filter in the second signal path for setting an amplification and a phase shift. Matching filters are proven means for setting an amplification and a phase shift, in particular depending on frequency of the audio signal received at the audio input.

In particular, the signal influencing circuit can comprise
a phase shifter or an allpass filter respectively in the first signal path and
a (digital) matching filter with a complex transfer function in the second signal path.

The phase shifter or allpass filter in particular provides a time delay for the first signal so that the processing time or the maximum group delay of the matching filter respectively is taken into consideration and a desired phase shift can be provided between the first signal and the second signal.

It should be noted that “gain” in general is similar term or synonym respectively for “amplification” throughout the disclosure.

Further advantageous embodiments are disclosed in the claims and in the description as well as in the figures.

Preferably, the phase shift fulfills the conditions 10°<φ<170° and 190°<φ<350° in at least a part of the frequency range of the sound system. In this way, the advantages of the proposed sound system are even more pronounced.

Advantageously, the signal influencing circuit additionally can comprise a non-linear actuator model of the actuator and an actuator resistance detector for detecting a DC resistance of the actuator, wherein the actuator model has a first actuator model input being connected to an input path leading to the matching filter, a second actuator model input being connected to an output of the actuator resistance detector and an output, which is coupled to the second signal path before the input path to the matching filter. In particular, the actuator model can output an actuator resonance characteristics signal, which is representative of resonance characteristics of the actuator (i.e. a signal representative of a resonance frequency and/or a quality factor or Q-factor of the actuator). More particularly, the actuator model can output the modeled back electromotive force of the actuator as the actuator resonance characteristics signal. The actuator resonance characteristics signal output by the actuator model is negatively coupled to the second signal path before the input path to the matching filter. If the actuator model outputs a negative actuator resonance characteristics signal or the negative modeled back electromotive force, it is positively coupled to the second signal path. By this, the resonance of the actuator is (actively) damped.

In another advantageous embodiment of the sound system, the signal influencing circuit additionally can comprise a non-linear speaker model of the speaker, a speaker resistance detector for detecting a DC resistance of the speaker and a movement difference detector for detecting a difference between a speaker movement parameter and an actuator movement parameter,
wherein the speaker model has a first speaker model input being connected to an input path leading to the phase shifter or allpass filter and a second speaker model input being connected to an output of the speaker resistance detector,
wherein the movement difference detector has a first input, which is connected to an output of the speaker model, a second input, which is connected to an output of the actuator model, and an output, which is coupled to the second signal path before the input path to the matching filter.

The speaker movement parameter and the actuator movement parameter may be chosen from the group: excursion, velocity, acceleration or momentum. Accordingly, the movement difference detector may be termed “excursion difference detector,” “velocity difference detector,” “acceleration difference detector” or “momentum difference detector”. Of course, the movement difference detector calculates the difference of the same type of parameter. Hence, an excursion difference detector calculates the difference between a speaker excursion and an actuator excursion, a velocity difference detector calculates the difference between a speaker velocity and an actuator velocity, and so on. In particular, the movement difference detector can be a modeled movement difference detector, which detects a difference between a modeled speaker movement parameter and a modeled actuator movement parameter.

It should be noted that the output of the movement difference detector is negatively coupled to the second signal path before the input path to the matching filter if the output reflects a difference between a speaker movement parameter and an actuator movement parameter. In contrast, said output is positively coupled to the second signal path if the output reflects a difference between an actuator movement parameter and a speaker movement parameter. By this, the resonance of the actuator is (actively) damped in view of a resonance of the speaker.

It should also be noted that the output of the actuator model in this embodiment outputs an actuator movement parameter (e.g. a modeled actuator excursion, a modeled actuator velocity, a modeled actuator acceleration or a modeled actuator momentum) whereas in the aforementioned embodiment, the actuator model preferably outputs the modeled actuator resonance characteristics signal (e.g. the modeled back electromotive force of the actuator). In case that both embodiments are combined, the actuator model may have two different outputs, one for the actuator movement parameter and the other for the modeled actuator resonance characteristics signal.

Generally, the signal influencing circuit may have optional driver stages or amplifiers respectively in the first and second signal paths to provide first and second signals powerful enough for the speaker and the actuator.

During operation of the actuator, its resonance characteristics including harmonics may change, in particular caused by a changing temperature of the actuator and/or caused by a changing level of the second electric signal fed into the actuator. By feeding back the actuator resonance characteristics signal (e.g. the back electromotive force of the actuator), these variations are taken into consideration and compensated respectively. Accordingly, the signal influencing circuit is better adapted to real conditions.

The very same counts for the speaker, whose resonance characteristics including harmonics may change as well, in particular again caused by a changing temperature and/or by a changing level of the first electric signal fed into the speaker. By feeding back the output signal of the movement difference detector, differences of the speaker behavior and the actuator behavior are taken into consideration and compensated respectively. By this, the movement of the moving mass of the actuator is better adapted to the movement of the moving mass of the speaker. Accordingly, the signal influencing circuit is adapted to real conditions even better.

In this context, it is advantageous to use the excursions of the speaker and the actuator as movement parameters because a very clear output signal of the movement difference detector is obtained for low frequencies then, which are particularly relevant for the vibration compensation.

In particular, the non-linear actuator model in the above embodiments can be provided to calculate physical quantities of a second order system based on Thiele/Small-parameters (with or without nonlinear parameters) related to the actuator and based on the signal fed to the matching filter in the second signal path. One of the calculated physical quantities can be the actuator resonance characteristics signal (e.g. the back electromotive force of the actuator), another mechanical physical quantity can be an excursion, a velocity, an acceleration or a momentum of the actuator.

In a quite similar way, the speaker model can be provided to calculate physical quantities of a second order system based on Thiele/Small-parameters (with or without nonlinear parameters) related to the speaker and based on the signal fed to the phase shifter/allpass filter in the first signal path.

The actuator resistance detector in particular can be designed to detect a DC resistance of the actuator, and the speaker resistance detector can be designed to detect a DC resistance of the speaker. In general, the behavior of the actuator or speaker is influenced by its (ohmic) DC resistance. Hence, the DC resistances can be used to adapt the actuator model and the speaker model to real and actual conditions, in particular to obtain accurate as possible modeled values and to avoid instabilities of the signal influencing circuit.

For example, the DC resistance can be obtained by measuring current and voltage at the actuator or speaker or at an element driving the same (e.g. at a driver stage or amplifier). The DC resistance depends on the temperature of the actuator voice coil(s) or on the speaker voice coil(s) respectively. So, if the DC resistance at a certain temperature and its dependency on the temperature are known, the (actual) DC resistance can also be obtained by measuring the temperature of the actuator or speaker. Alternatively, the (actual) DC resistance can also be obtained by measuring the electric power being transferred to the actuator or speaker because the power has a direct influence on the temperature of the same.

In more detail, the actuator resistance detector or the speaker resistance detector can be provided to extract a low frequency pilot tone signal from both a voltage and a current fed to the actuator or speaker respectively. In this case, the instantaneous DC resistance value can be obtained by division of the instantaneous RMS values of the pilot tone's voltage and said current. Said instantaneous DC resistance value then can be output at the actuator resistance detector output or speaker resistance detector output respectively.

Finally, the movement difference detector is explained in more detail. It can be embodied or seen as an inverse actuator model, which, based on the mechanical physical quantities provided by the actuator model and the speaker model (strictly speaking based on the difference of said mechanical physical quantities), calculates physical quantities of a second order system based on the same Thiele/Small-parameters (with or without nonlinear parameters) as the actuator model has and outputs the calculated voltage at its output.

It should also be noted that the output of the actuator resistance detector and/or the speaker resistance detector as well as the second actuator model input and/or the second speaker model input can be provided as multidimensional inputs and outputs. That means that not just one parameter but more parameters can be transferred via such an input or output. For example, an actuator resonance parameter can (additionally) be transferred via the actuator resistance detector output and the second actuator model input, or a speaker resonance parameter can (additionally) be transferred via the speaker resistance detector output and the second speaker model input. In this way, also external influences on the resonance of the actuator and/or speaker, which are not linked to temperature or signal level, can be taken into consideration and compensated respectively. For example, the resonance of the actuator and/or speaker may change if the electronic device, which the sound system is built into, is linked to a heavy mass like it is the case if a user holds the electronic device in his hand(s) or touches a display of the electronic device with a finger. An actuator resonance parameter can directly be the resonance frequency of the actuator, a phase shift between voltage and current of the second electric signal, which is a measure for the resonance frequency of the actuator as well, or a phase shift deviation from 0° between voltage and current of the second electric signal, which is a measure for a resonance frequency change of the actuator. Quite similar, a speaker resonance parameter can directly be the resonance frequency of the speaker, a phase shift between voltage and current of the first electric signal, which is a measure for the resonance frequency of the speaker as well, or a phase shift deviation from 0° between voltage and current of the first electric signal, which is a measure for the resonance frequency shift of the speaker. For example, a phase shift of 0° means operation at the resonance frequency. It should be noted at this point that the phase shift between the voltage and the current of the first electric signal and the phase shift between the voltage and the current of the second electric signal must not confused with the phase shift between the first and second electric signal.

Preferably, a ratio between a moving mass of the speaker and the moving mass of the actuator is in a range of 0.5 to 5. In this way, an excursion of the actuator is kept in a beneficial range and neither is too high nor too low. The moving mass of the speaker, for example, can be the mass of the speaker voice coil plus the mass of the movable part of the membrane.

In another preferred embodiment of the sound system, an angle α between the first axis and the second axis is can be in a range of 0°≤α≤45°. In this way, space may be saved for the arrangement of the speaker and the actuator under certain conditions.

In yet another preferred embodiment of the sound system, the speaker comprises a back volume, wherein the actuator is arranged out of or inside said back volume. If the actuator is arranged out of the back volume, the back volume is independent of a size and a shape of actuator. If the actuator is arranged within the back volume, a compact and robust sound system can be obtained. In particular, a housing encompassing the back volume may form coupling means in this case.

Advantageously, the sound system additionally may comprise an input for a supply voltage or a switch off signal and a power saving control, which is designed for reducing an amplitude of the second electric signal compared to a normal operating setting or for turning off generation of the second electric signal below a threshold value of the supply voltage or in case that the switch off signal is received.

If the input is connected to a supply voltage for the sound system, the sound system itself can reduce an amplitude of the second electric signal or turn off the generation of the second electric signal in case of low supply voltage. However, changing the amplitude of the second electric signal between an energy saving mode and a normal operating setting or switching on and off the generation of the second electric signal between the energy saving mode and the normal operating setting may also be triggered by means of a switch off signal provided by an electronic device, which the sound system is built into.

In particular, the generation of the second electric signal may be influenced by changing the parameters of the matching filter by the power saving control. For example, a gain of the matching filter may be set to lower values or even to zero in some frequency ranges or in all frequency ranges to save energy. Alternatively, an additional power saving filter switched in series with the matching filter may be provided for the same reason. For example, the gain of the power saving filter may be set to low values or even to zero in some frequency ranges or in all frequency ranges in a power saving mode and set to “1” in all frequency ranges in a normal operating mode.

Advantageously, changing an amplitude of the second electric signal or switching on and off the generation of the second electric signal does not change the sound output by the speaker or just to a very little extent. The only influence of the actuator on sound generation is a possible movement of the whole speaker caused by a transfer of the actuator movement to the speaker via the coupling means. Strictly speaking, sound generation is based on a movement of the membrane relative to a speaker frame or housing caused by the speaker motor plus a movement of the whole speaker caused by the actuator motor. However, as said, the second movement is very small and hence the influence on sound generation is very small, too. If the speaker frame or housing is fixed in space, for example if it is mounted to a heavy mass, this influence is even zero.

It should be noted in this context that in case that the generation of the second electric signal is turned off in the energy saving mode, the energy saving mode equals the reference setting in the aforementioned tuning of the operating setting to obtain a substantial vibration reduction at particular points of the housing and/or frame of the electronic device or of the whole the housing and/or frame. In this case, accordingly, the aforementioned conditions can be tested by switching the electronic device to the energy saving mode.

Hence, the considerations, which have been made to sound generation in energy saving mode, equally apply to the tuning of the operating setting, too. That means that the sound output by the speaker is not influenced or is not influenced much during the tuning procedure or when the electronic device is transferred to the reference mode or reference setting. This influence can even be drawn to zero if the speaker frame or housing is fixed in space, for example if it is mounted to a heavy mass.

### BRIEF DESCRIPTION OF THE DRAWINGS

These and other aspects, features, details, utilities, and advantages of the invention will become more fully apparent from the following detailed description, appended claims, and accompanying drawings, wherein the drawings illustrate features in accordance with exemplary embodiments of the invention, and wherein:

FIG. 1 shows a schematic view of an exemplary sound system;

FIG. 2 shows sectional view of a sound system, where the actuator is arranged out of a back volume of the speaker;

FIG. 3 shows sectional view of a sound system, where the actuator is arranged within a back volume of the speaker;

FIG. 4 shows a schematic view of a signal influencing circuit with an actuator model and an actuator resistance detector;

FIG. 5 like FIG. 4 but with an additional speaker model, a speaker resistance detector and a movement difference detector;

FIG. 6 shows a schematic view of a signal influencing circuit with a power saving control;

FIG. 7 shows a top view of an exemplary electronic device;

FIG. 8 exemplary graphs of the phase shift between the first and second signal over frequency;

FIG. 9 exemplary gains of the second signal over frequency and

FIG. 10 shows a schematic sectional view of a sound system with a tilted first axis.

Like reference numbers refer to like or equivalent parts in the several views.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It must be noted that, as used in this specification and the appended claims, the singular forms “a,” “an” and “the” include plural referents unless the content clearly dictates otherwise.

The terms “first,” “second,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

All directional references (e.g., “plus,” “minus,” “upper,” “lower,” “upward,” “downward,” “left,” “right,” “leftward,” “rightward,” “front,” “rear,” “top,” “bottom,” “over,” “under,” “above,” “below,” “vertical,” “horizontal,” clockwise,” and “counterclockwise”) are only used for identification purposes to aid the reader's understanding of the present disclosure, and do not create limitations, particularly as to the position, orientation, or use of the any aspect of the disclosure. It is to be understood that the terms so used are interchangeable under appropriate circumstances such that the embodiments of the invention described herein are, for example, capable of operation in other orientations than those illustrated or otherwise described herein.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose.

Joinder references (e.g., “attached,” “coupled,” “connected,” and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims. Nevertheless, the term “connected” within the disclosure in particular can mean “direct connection” (without intermediate parts), and the term “couple” within the disclosure in particular can mean “direct or indirect connection” (with or without intermediate parts).

All numbers expressing measurements and so forth used in the specification and claims are to be understood as being modified in all instances by the term “about” or “substantially,” which particularly means a deviation of ±10% from a reference value.

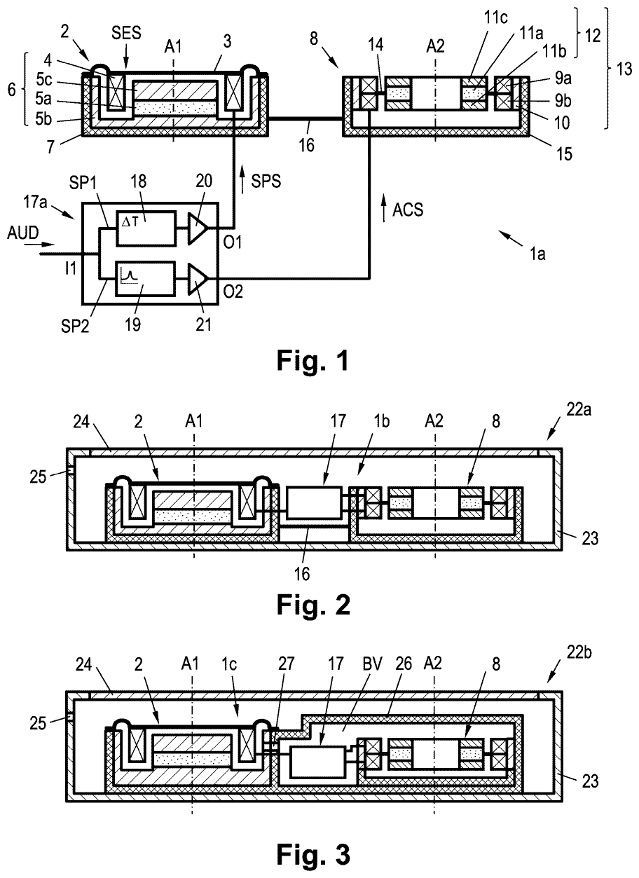

FIG. 1 shows a schematic view of a first example of a sound system 1a. The sound system la comprises a speaker 2 with a membrane 3 as well as with a speaker voice coil 4, a speaker magnet 5a (magnetized in an axial direction along a first axis A1), a speaker pot 5b and a speaker top plate 5c. The speaker magnet 5a, the speaker pot 5b and the speaker top plate 5c form a speaker magnet system. The voice coil 4 and the speaker magnet system both form a speaker motor 6. Moreover, the speaker 2 comprises a speaker housing or speaker frame 7 accommodating the speaker magnet system. The membrane 3 is attached to the speaker housing or speaker frame 7 and to the speaker voice coil 4.

A current through the speaker voice coil 4 and a magnetic flux generated by the speaker magnet 5a and guided by the speaker pot 5b and the speaker top plate 5c cause a movement of the speaker voice coil 4 and thus of the membrane 3. Generally, the speaker motor 6 is designed for moving the membrane 3 up and down along the first axis A1.

Further on, the sound system la comprises an actuator 8 with actuator voice coils 9a, 9b, an outer actuator ring 10, an actuator magnet 11a (magnetized in an axial direction along a second axis A2), an actuator bottom plate 11b and an actuator top plate 11c. The outer actuator ring 10, the actuator magnet 11a, the actuator bottom plate 11b and the actuator top plate 11c together form an actuator magnet system. The outer actuator ring 10 forms a fixed part of the actuator magnet system, and the actuator magnet 11a, the actuator bottom plate 11b and the actuator top plate 11c together form a movable part of the actuator magnet system and a moving mass 12 respectively in this example. The actuator voice coils 9a, 9b are attached to the outer actuator ring 10 here. The actuator voice coils 9a, 9b together with the magnet system (i.e. together with the fixed part of actuator magnet system and the movable part of actuator magnet system) form an actuator motor 13. In addition, the actuator 8 comprises springs 14, by which the moving mass 12 is movably coupled to the fixed part of the actuator 8 (here to the actuator voice coils 9a, 9b). Finally, the actuator 8 comprises an actuator housing/actuator frame 15 accommodating the outer actuator ring 10.

A current through the actuator voice coils 9a, 9b and a magnetic flux generated by the actuator magnet 11a and guided by the outer actuator ring 10, the actuator bottom plate 11b and the actuator top plate 11c cause a movement of the moving mass 12. Generally, the actuator motor 13 is designed for moving the moving mass 12 up and down along the second axis A2, which is displaced from the first axis A1 and which in this example is parallel to the first axis Al.

Additionally, the sound system la comprises coupling means 16 for mechanically coupling the actuator 8 to the speaker 2. For example, a dedicated elastic element between the actuator 8 and the speaker 2 can be provided for this reason, in particular a bar or plate made of metal and/or plastic.

Generally, one should note that the speaker 2, the actuator 8 and the coupling means 16 are just schematically drawn, and other embodiments are possible as well. For example, proportions of the speaker 2 and parts thereof may be different. Furthermore, the speaker magnet 5a may be bigger in alternative designs and/or the speaker 2 may have more than one speaker voice coil 4 (e.g. two). In addition, the actuator magnet system may have a different design and/or the actuator 8 may have a different count of actuator voice coils 9a, 9b. For example, the actuator 8 may have only one actuator voice coil 9a, 9b. One should also note that proportions of the actuator 8 and parts thereof are just exemplary as well. For example, the actuator magnet 11a may be bigger in alternative designs.

One should also note that the speaker 2 is for transforming electrical power into sound, whereas the actuator 8 shall transform electrical power only into movement and force. As can be envisaged from FIG. 1, the actuator 8 has no membrane 3 and accordingly the actuator motor 13 is not designed for moving a membrane 3 along the second axis A2. In other words, the actuator 8 is designed for transforming an electric current into a movement of the moving mass 12 without dedicated or pronounced sound generation. Generation of sound in view of the actuator 8 is solely an unused side effect. In particular, an average sound pressure level of the speaker 2 measured in an orthogonal distance of 10 cm from a sound emanating surface SES of the membrane 3 can be at least 50 dB_SPL and an average sound pressure level of the actuator 8 measured at the same directional distance can be at most 20 dB_SPL in the same frequency range.

Furthermore, the sound system 1a comprises a signal influencing circuit 17a having an audio input I1, a speaker output O1, an actuator output O2, a first signal path SP1 from the audio input I1 to the speaker output O1 and a second signal path SP2 from the audio input I1 to the actuator output O2. The signal influencing circuit 17a is designed to feed a first electric signal SPS to the speaker motor 6 via the speaker output O1 and a second electric signal ACS to the actuator motor 13 via the actuator output O2 based on an audio signal AUD received at the audio input I1.

It should be noted that FIG. 1 shows only a single illustrative signal line to the actuator 8 although the actuator 8 in this example comprises two actuator voice coils 9a, 9b. Accordingly, in reality there may be two signal lines leading to the actuator 8 (see also FIGS. 2 and 3 in this context). It should also be noted that the directions of the currents flowing through the two actuator voice coils 9a, 9b are antiparallel. This can be achieved by opposite winding directions or by antiphase second electric signals ACS.

The signal influencing circuit 17a is designed to vary an amplification or gain of the second electric signal ACS over a frequency range of the sound system 1a and/or to set a phase shift φ between the first electric signal SPS and the second electric signal ACS. The phase shift φ is non-equal to 0° and 180° (or in other words is in a range of 0°<φ<180° and 180°<φ<360° in at least a part of the frequency range of the sound system 1a.

In this example, the signal influencing circuit 17a comprises a phase shifter or an allpass filter 18 respectively in the first signal path SP1 and a (digital) matching filter 19 in the second signal path SP2. The matching filter 19 is used here to set an amplification and/or a phase shift, in particular depending on a frequency of the audio signal AUD received at the audio input I1, and can have a complex transfer function. The matching filter 19 is used to take into consideration and to compensate physical differences between the speaker 2 and the actuator 8.

In more detail, the matching filter 19 can be provided for matching the resulting forces of the actuator 8 to those generated by the speaker 2.

The phase shifter or allpass filter 18 in particular provides a time delay for the first signal SPS so that the processing time or the maximum group delay of the matching filter 19 respectively is taken into consideration and compensated, and a desired phase shift can be provided between the first signal SPS and the second signal ACS even in view of said processing time or maximum group delay.

Finally, the sound system 1a comprises an optional speaker amplifier/speaker driver stage 20 and an optional actuator amplifier/actuator driver stage 21, which are designed for amplifying the signals coming from the phase shifter or allpass filter 18 and the matching filter 19 up to appropriate signal levels of the first signal SPS and the second signal ACS.

Generally, the actuator 8, in detail its moving mass 12, is provided for compensating a vibration of the speaker motor 6, which is explained in detail later. Preferably, a ratio between a moving mass of the speaker 2, which in this case is the mass of the speaker voice coil 4 plus the mass of the movable part of the membrane 3, and the moving mass 12 of the actuator 8 is in a range of 0.5 to 5. In this way, an excursion of the actuator 8 is kept in a beneficial range and neither is too high nor too low.

FIG. 2 shows a schematic sectional view of a second example of a sound system 1b, which is built into an electronic device 22a here. The electronic device 22a comprises a housing and/or a frame 23 with an optional display 24 and an optional sound port 25. For example, the electronic device 22a can be embodied as a mobile phone, a tablet computer or a laptop computer. Further on, for example, the signal influencing circuit 17 can be embodied as the signal influencing circuit 17a depicted in FIG. 1.

The sound system 1b comprises dedicated coupling means 16 for mechanically coupling the actuator 8 to the speaker 2. However, the speaker 2 and the actuator 8 are also mounted to the housing and/or frame 23, which form additional coupling means for the speaker 2 and the actuator 8. Hence the mechanical coupling between the actuator 8 and the speaker 2 is partially formed by said housing and/or frame 23. It should also be noted that FIG. 2 shows two dedicated signal lines to the actuator voice coils 9a, 9b.

Sound generated by the speaker 2 leaves the housing and/or frame 23 through the sound port 25. However, other possibilities of sound transfer are imaginable as well. One can also realize from FIG. 2 that the actuator 8 does not contribute to sound generation because it does not compress or decompress the air volume within the housing and/or frame 23. Instead, the space between the moving mass 12 and the actuator voice coils 9a, 9b as well as the center hole in the moving mass 12 basically form an acoustic short circuit. Nevertheless, one should note that the actuator 8 would also function without such a center hole in the moving mass 12 and would have an even higher force factor then.

In the example of FIG. 2, the actuator 8 is arranged out of a back volume BV of the speaker 2. However, the actuator 8 may also be arranged inside said back volume BV like this is the case in the example of FIG. 3.

In detail, FIG. 3 shows a sound system 1c, which is built into an electronic device 22b. Again, the electronic device 22b comprises a housing and/or a frame 23 with an optional display 24 and an optional sound port 25. Moreover, the sound system 1c comprises a common speaker and actuator housing or frame 26 and an air connection 27 to the air volume behind the membrane 3. Again, sound generated by the speaker 2 leaves the housing and/or frame 23 through the sound port 25 and again the actuator 8 does not contribute to sound generation because of the reasons stated before. It should be noted that that the outer actuator ring 10 is arranged on a dedicated holder in this example but it may also be arranged on a properly shaped common speaker and actuator housing or frame 26.

In the example of FIG. 3, there are no dedicated coupling means 16 but the mechanical coupling between the speaker 2 and the actuator 8 is done by the housing and/or frame 23 and additionally by the common speaker and actuator housing or frame 26. Again, in FIG. 3 two dedicated signal lines to the actuator voice coils 9a, 9b are shown.

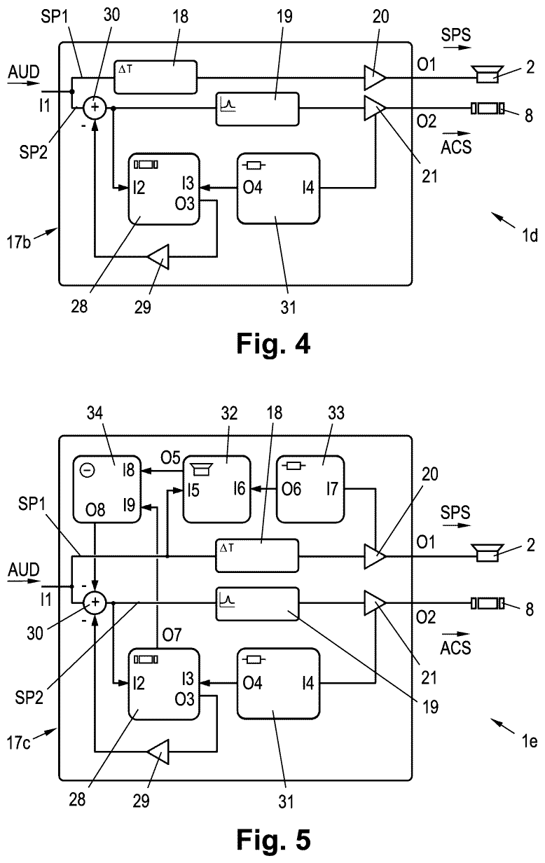

FIG. 4 now shows a further embodiment of a sound system 1d, which is similar to the sound system la of FIG. 1, but wherein the signal influencing circuit 17b additionally comprises a non-linear actuator model 28 of the actuator 8, an actuator model amplifier 29, a summing unit 30 and an actuator resistance detector 31. The non-linear actuator model 28 comprises a first and a second actuator model input I2, I3 and an actuator model output O3, and the actuator resistance detector 31 comprises an actuator resistance detector input I4 and an actuator resistance detector output O4.

The actuator resistance detector input I4 is connected to an output of the actuator amplifier/actuator driver stage 21, and the actuator resistance detector input I4 is designed to detect a DC resistance of the actuator 8. The DC resistance of the actuator 8 is output at the actuator resistance detector output O4 and fed into the non-linear actuator model 28 via the second actuator model input I3. The first actuator model input I2 is connected to an input path leading to the matching filter 19 (downstream of the summing unit 30). The actuator model output O3 is coupled to the second signal path SP2 before the input path to the matching filter 19. In this example, the actuator model output O3 is connected to the summing unit 30 via the actuator model amplifier 29. Further on, in this example, the actuator model 28 outputs an actuator resonance characteristics signal, which is representative of resonance characteristics of the actuator 8 (i.e. a signal representative of a resonance frequency and/or a quality factor or Q-factor of the actuator 8) at the actuator model output O3. More particularly, the actuator model 28 can output the modeled back electromotive force of the actuator 8 as the actuator resonance characteristics signal at the actuator model output O3. The actuator resonance characteristics signal being output at the actuator model output O3 is negatively coupled to the second signal path SP2 before the input path to the matching filter 19 by means of the summing unit 30. However, if the actuator model 28 outputs the negative actuator resonance characteristics signal (e.g. a negative modeled back electromotive force), it is positively coupled to the second signal path SP2. By this, the resonance of the actuator 8 is (actively) damped.

During operation of the actuator 8, its resonance characteristics including harmonics may change, in particular caused by a changing temperature of the actuator 8 and/or caused by a changing level of the second electric signal ACS fed into the actuator 8. By feeding back the actuator resonance characteristics signal (e.g. the back electromotive force of the actuator 8), these variations are taken into consideration and compensated respectively. Accordingly, the signal influencing circuit 17b is better adapted to real conditions.

In particular, the non-linear actuator model 28 can be provided to calculate physical quantities of a second order system based on Thiele/Small-parameters (with or without nonlinear parameters) related to the actuator 8 and based on the input signal at the first actuator model input I2. One of the calculated physical quantities is the actuator resonance characteristics signal (e.g. the back electromotive force of the actuator 8), which is output at the actuator model output O3.

As already said, the actuator resistance detector 31 is designed to detect a DC resistance of the actuator 8. The (ohmic) DC resistance of the actuator 8 depends on the temperature of the actuator voice coils 9a, 9b and influences the behavior of the actuator 8. Hence, the DC resistance is used herein to adapt the actuator model 28 to real and actual conditions, in particular to obtain an accurate as possible value of the actuator resonance characteristics signal or back electromotive force respectively from the actuator model 28.

For example, the DC resistance can be obtained by measuring current and voltage at the actuator voice coils 9a, 9b or at an element driving the actuator voice coils 9a, 9b (e.g. at the actuator amplifier/actuator driver stage 21). If the DC resistance at a certain temperature and its dependency on the temperature are known, the (actual) DC resistance can also be obtained by measuring the temperature of the actuator 8, in particular by measuring the temperature of its actuator voice coils 9a, 9b. Alternatively, the (actual) DC resistance can also be obtained by measuring the electric power, which is transferred to the actuator voice coils 9a, 9b via the second signal ACS because the power has a direct influence on the temperature of the same. In the example of FIG. 4, the actuator resistance detector input I4 receives current and voltage values from the actuator amplifier/actuator driver stage 21. However, the actuator resistance detector input I4 may also be connected to a temperature sensor of the actuator 8 alternatively. By the proposed measures, instability of the control loop formed by the actuator resistance detector 31, the non-linear actuator model 28, the actuator model amplifier 29, the summing unit 30 and the matching filter 19 can be avoided.

In more detail, the actuator resistance detector 31 can be provided to extract a low frequency pilot tone signal from both a voltage measured at the actuator output O2 as well as from a current measured in the actuator amplifier/actuator driver stage 21. In this case, the instantaneous DC resistance value can be obtained by division of the instantaneous RMS values of the pilot tone's voltage and said current. Said instantaneous DC resistance value then can be output at the actuator resistance detector output O4.

FIG. 5 shows yet another embodiment of a sound system 1e, which is similar to the sound system 1d of FIG. 4, but wherein the signal influencing circuit 17c additionally comprises a non-linear speaker model 32 of the speaker 2, a speaker resistance detector 33 for detecting a DC resistance of the speaker 2 and a movement difference detector 34 for detecting a difference between a speaker movement parameter and an actuator movement parameter. The speaker model 32 has a first speaker model input I5 being connected to an input path leading to the phase shifter or allpass filter 18 and a second speaker model input I6 being connected to an output O6 of the speaker resistance detector 33. The movement difference detector 34 has a first input I8, which is connected to an output O5 of the speaker model 32, a second input I9, which is connected to a (second) output O7 of the actuator model 28, and an output O8, which is coupled to the second signal path SP2 before the input path to the matching filter 19.

The speaker movement parameter and the actuator movement parameter may be chosen from the group: excursion, velocity, acceleration or momentum. Accordingly, the movement difference detector 34 may be termed “excursion difference detector,” “velocity difference detector,” “acceleration difference detector” or “momentum difference detector”. Of course, the movement difference detector 34 calculates the difference of the same type of parameter. Hence, an excursion difference detector calculates the difference between a speaker excursion and an actuator excursion, a velocity difference detector calculates the difference between a speaker velocity and an actuator velocity, and so on. In particular, the movement difference detector 34 can be a modeled movement difference detector, which detects a difference between a modeled speaker movement parameter and a modeled actuator movement parameter.

It should be noted that the movement difference detector output O8 is negatively coupled to the second signal path SP2 before the input path to the matching filter 19 if the movement difference detector output O8 reflects a difference between a speaker movement parameter and an actuator movement parameter (as it is the case in FIG. 5), and is positively coupled to the second signal path SP2 if the movement difference detector output O8 reflects a difference between an actuator movement parameter and a speaker movement parameter. By this, the resonance of the actuator 8 is (actively) damped in view of a resonance of the speaker 2.

It should also be noted that the first output O3 of the actuator model 28 and the second output O7 of the actuator model 28 do not necessarily output the same type of parameter. Instead, the first actuator model output O3 may output a modeled actuator resonance characteristics signal (e.g. the modeled back electromotive force of the actuator 8), whereas the second actuator model output O7 may output a modeled actuator excursion, a modeled actuator velocity, a modeled actuator acceleration or a modeled actuator momentum.

As mentioned before, during operation of the actuator 8, its resonance characteristics including harmonics may change. The very same counts for the speaker 2, whose resonance characteristics including harmonics may change as well, in particular again caused by a changing temperature and/or by a changing level of the first electric signal SPS fed into the speaker 2. By feeding back the output signal of the movement difference detector 34, differences of the speaker behavior and the actuator behavior are taken into consideration and compensated respectively. By this, the movement of the moving mass 12 of the actuator 8 is better adapted to the movement of the moving mass of the speaker 2 (which is the mass of the speaker voice coil 4 plus the mass of the movable part of the membrane 3 here). Accordingly, the signal influencing circuit 17c is adapted to real conditions even better.

In this context, it is advantageous to use the excursions of the speaker 2 and the actuator 8 as movement parameters because a very clear output signal of the movement difference detector 34 is obtained for low frequencies then, which are particularly relevant for the vibration compensation.

In more detail, the actuator model 28 calculates physical quantities of a second order system based on Thiele/Small-parameters (with or without nonlinear parameters) related to the actuator 8 and based on the input signal at the first actuator model input I2 as already indicated before. One of the calculated physical quantities is the actuator resonance characteristics signal (e.g. the back electromotive force of the actuator 8) being output at the actuator model output O3, another mechanical physical quantity (excursion, velocity, acceleration or momentum) is output at the second actuator model output O7.

In a quite similar way, the speaker model 32 can be provided to calculate physical quantities of a second order system based on Thiele/Small-parameters (with or without nonlinear parameters) related to the speaker 2 and based on the input signal at the first speaker model input I5. One of the calculated mechanical physical quantities (excursion, velocity, acceleration or momentum) is output at the speaker model output O5.

In addition, the speaker resistance detector 33 works quite similar to the actuator resistance detector 31 and is provided for a similar reason. In detail, the speaker resistance detector 33 is designed to detect a DC resistance of the speaker 2. The (ohmic) DC resistance of the speaker 2 depends on the temperature of the speaker voice coil 4 and influences the behavior of the speaker 2. Hence, the DC resistance is used herein to adapt the speaker model 32 to real and actual conditions.

For example, the DC resistance can be obtained by measuring current and voltage at the speaker voice coil 4 or at an element driving the speaker voice coil 4 (e.g. at the speaker amplifier/speaker driver stage 20). If the DC resistance at a certain temperature and its dependency on the temperature are known, the (actual) DC resistance can also be obtained by measuring the temperature of the speaker 2, in particular by measuring the temperature of its speaker voice coil 4. Alternatively, the (actual) DC resistance can also be obtained by measuring the electric power, which is transferred to the speaker voice coil 4 via the first signal SPS because the power has a direct influence on the temperature of the same. In the example of FIG. 5, speaker resistance detector input I7 receives current and voltage values from the speaker amplifier/speaker driver stage 20. However, the speaker resistance detector input I7 may also be connected to a temperature sensor of the speaker 2 alternatively.

In more detail, the speaker resistance detector 33 can be provided to extract a low frequency pilot tone signal from both a voltage measured at the speaker output O1 as well as from a current measured in the speaker amplifier/speaker speaker driver stage 20. In this case, the instantaneous DC resistance value can be obtained by division of the instantaneous RMS values of the pilot tone's voltage and said current. Said instantaneous DC resistance value then can be output at the speaker resistance detector output O6.

Finally, the movement difference detector 34 is explained in more detail. It can be embodied or seen as an inverse actuator model, which, based on the mechanical physical quantities provided by the actuator model 28 and the speaker model 32 (strictly speaking based on the difference of said mechanical physical quantities), calculates physical quantities of a second order system based on the same Thiele/Small-parameters (with or without nonlinear parameters) as the actuator model 28 has and outputs the calculated voltage at the movement difference detector output O8.

It should also be noted that the actuator resistance detector output O4 and/or the speaker resistance detector output O6 as well as the second actuator model input I3 and/or the second speaker model input I6 can be provided as multidimensional inputs and outputs. That means that not just one parameter but more parameters can be transferred via such an input I3, I6 or output O4, O6. For example, an actuator resonance parameter can (additionally) be transferred via the actuator resistance detector output O4 and the second actuator model input I3, or a speaker resonance parameter can (additionally) be transferred via the speaker resistance detector output O6 and the second speaker model input I6. In this way, also external influences on the resonance of the actuator 8 and/or speaker 2, which are not linked to temperature or signal level, can be taken into consideration and compensated respectively. For example, the resonance of the actuator 8 and/or speaker 2 may change if the electronic device 22a, 22b, which the sound system 1e is built into, is linked to a heavy mass like it is the case if a user holds the electronic device 22a, 22b in his hand(s) or touches a display 24 of the electronic device 22a, 22b with a finger. An actuator resonance parameter can directly be the resonance frequency of the actuator, a phase shift between voltage and current of the second electric signal ACS, which is a measure for the resonance frequency of the actuator 8 as well, or a phase shift deviation from 0° between voltage and current of the second electric signal ACS, which is a measure for a resonance frequency change of the actuator 8. Quite similar, a speaker resonance parameter can directly be the resonance frequency of the speaker, a phase shift between voltage and current of the first electric signal SPS, which is a measure for the resonance frequency of the speaker 2 as well, or a phase shift deviation from 0° between voltage and current of the first electric signal SPS, which is a measure for the resonance frequency shift of the speaker 2. For example, a phase shift of 0° means operation at the resonance frequency. It should be noted at this point that the phase shift between the voltage and the current of the first electric signal SPS and the phase shift between the voltage and the current of the second electric signal ACS must not confused with the phase shift o between the first and second electric signal SPS, ACS.

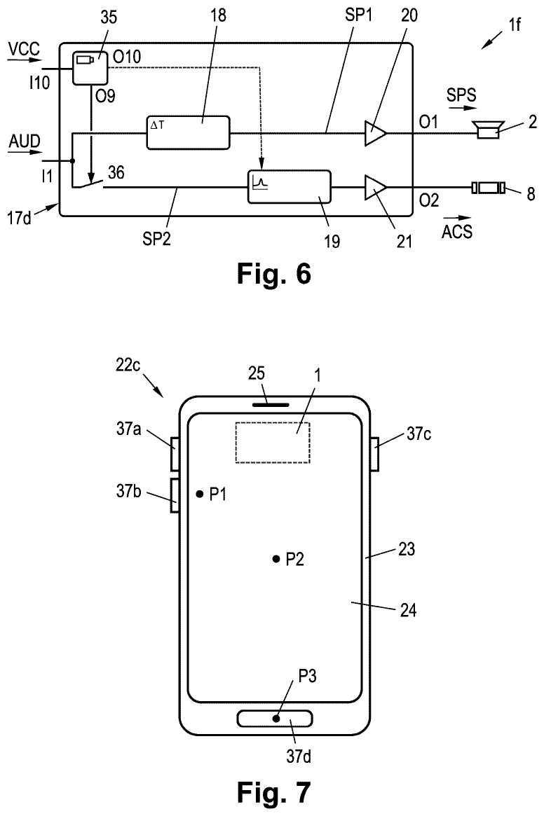

FIG. 6 now shows a sound system 1f, which is similar to the sound system 1a of FIG. 1 but which additionally comprises an input I10 for a supply voltage or a switch off signal VCC and a power saving control 35 with a first and a second power saving switching output O9, O10. The first power saving switching output O9 is connected to a power saving switch 36 and the second power saving switching output O10 is connected to the matching filter 19. It should be noted that one of the outputs O9, O10 is sufficient to provide a power saving function but however both may be embodied in the sound system 1f at the same time as well. The power saving control 35 is designed for reducing an amplitude of the second electric signal ACS compared to a normal operating setting or for turning off generation of the second electric signal ACS below a threshold value of the supply voltage VCC or in case that the switch off signal VCC is received.

For example, turning off generation of the second electric signal ACS can be done by opening the power saving switch 36 in the second signal path SP2 as this is the case in FIG. 6. Additionally or alternatively, the generation of the second electric signal ACS may be influenced by changing the parameters of the matching filter 19 accordingly as this is indicated by the dashed line leading from the output 10 of the power saving control 35 to the matching filter 19. For example, a gain of the matching filter 19 may be set to lower values or even to zero in some frequency ranges or in all frequency ranges to save energy. Alternatively, an additional power saving filter switched in series with the matching filter 19 may be provided for the same reason. For example, the gain of the power saving filter may be set to low values or even to zero in some frequency ranges or in all frequency ranges in a power saving mode and set to “1” in all frequency ranges in a normal operating mode. In fact, setting the gain of the matching filter 19 or of an additional power saving filter to zero equals turning off generation of the second electric signal ACS or opening power saving switch 36 respectively.

If the input I10 is connected to a supply voltage VCC for the sound system 1f, the sound system 1f itself can reduce an amplitude of the second electric signal ACS or turn off the generation of the second electric signal ACS in case of low supply voltage VCC. However, changing the amplitude of the second electric signal ACS between an energy saving mode and a normal operating setting or switching on and off the generation of the second electric signal ACS between the energy saving mode and the normal operating setting may also be triggered by means of a switch off signal provided by an electronic device 22a, 22b, which the sound system 1f is built into.

Advantageously, changing an amplitude of the second electric signal ACS or switching on and off the generation of the second electric signal ACS does not change the sound output by the speaker 2 or just to a very little extent. The only influence of the actuator 8 on sound generation is a possible movement of the whole speaker 2 caused by a transfer of the actuator movement to the speaker 2 via the mechanical coupling between the speaker 2 and the actuator 8 (e.g. via the coupling means 16, 23, 26). Strictly speaking, sound generation is based on a movement of the membrane 3 relative to the speaker frame or housing 7 caused by the speaker motor 6 plus a movement of the whole speaker 2 caused by the actuator motor 13. However, as said, the second movement is very small and hence the influence on sound generation is very small, too. If the speaker frame or housing 7 is fixed in space, for example if it is mounted to a heavy mass, this influence is even zero.

It should be noted that the power saving features of FIG. 6 can be integrated in any of the signal influencing circuits 17, 17a . . . 17c.

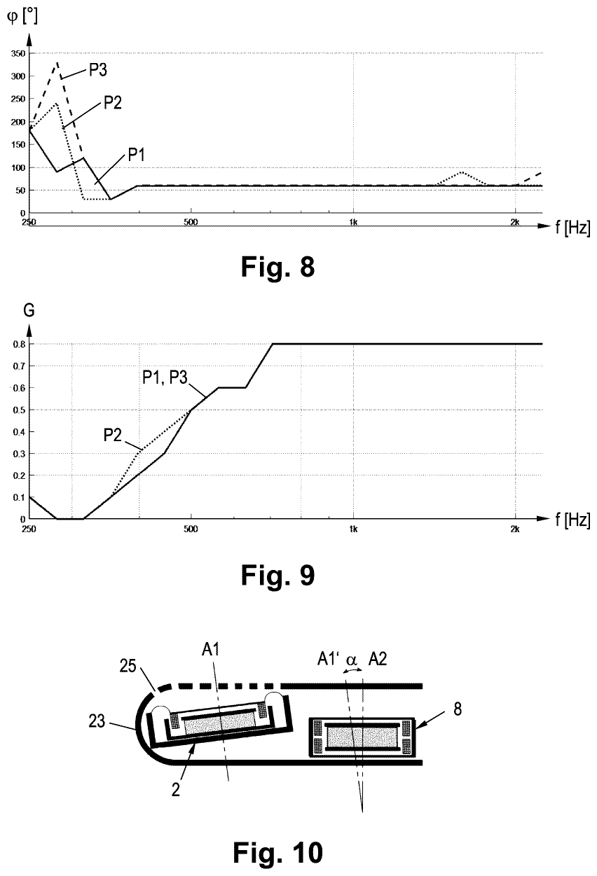

The function or use of the vibration compensation is now explained in detail by reference to FIGS. 7 to 9. FIG. 7 shows top view of an exemplary electronic device 22c, FIG. 8 shows exemplary graphs of the phase shift between the first signal SPS and the second signal ACS over a frequency f, and FIG. 9 shows exemplary gains G of the second signal ACS over the frequency f.

In detail, the exemplary electronic device 22c of FIG. 1 is embodied as a smartphone and comprises a housing and/or a frame 23 with a display 24 and a sound port 25. Moreover, the electronic device 22c comprises a sound system 1, which for example may be embodied as any of the sound systems 1a. . . . 1f, having a signal influencing circuit (not explicitly shown in FIG. 7), which for example may be embodied as any of the signal influencing circuits 17a . . . 17d. In addition, the electronic device 22c comprises four buttons 37a . . . 37d. Finally, three exemplary points or locations P1 . . . P3 on the electronic device 22c are depicted in FIG. 7.

Advantageously, the sound system 1 or its signal influencing circuit 17, 17a . . . 17d respectively, in an operating setting can be set in a way that in at least a part of the frequency range of the sound system 1, an amplitude of a mechanical oscillation at a particular point P1 . . . P3 of the housing and/or frame 23 of the electronic device 22c is below 50% of an amplitude of a mechanical oscillation at said particular point P1 . . . P3 of the housing and/or frame 23 in a reference setting where the actuator 8 is switched off.

Because the actuator 8 is switched off in the reference setting, it equals the energy saving mode in case that the generation of the second electric signal ACS is turned off there. In this case, accordingly, the above condition can be tested by switching the signal influencing circuit 17, 17a . . . 17d to the energy saving mode. In general, the test can be performed by switching off the second signal path SP2, by cutting off the actuator 8 from the signal influencing circuit 17, 17a . . . 17d or by setting zero gain G in the matching filter 19 or in an additional power saving filter of the signal influencing circuit 17, 17a . . . 17d.

It should be noted that the considerations, which have been made to sound generation in energy saving mode, equally apply here, too. That means that the sound output by the speaker 2 is not influenced or is not influenced much during testing the above condition or when the signal influencing circuit 17, 17a . . . 17d is transferred to the reference setting. This influence can even be drawn to zero if the speaker frame or housing 7 is fixed in space, for example if it is mounted to a heavy mass.

Accordingly, the sound system 1 (strictly speaking its signal influencing circuit 17, 17a . . . 17d) can be tuned in a way that a vibration at particular points P1 . . . P3 of the housing and/or frame 23 of the electronic device 22c is substantially reduced. For this purpose, during a tuning process, the amplification/gain G and/or the phase shift φ is varied until appropriate values have been found. These points P1 . . . P3 can be located at movable elements as it is the case for point P3 being arranged at or on button 37d. Alternatively, the points P1 . . . P3 can be located anywhere on the electronic device 22c as it is the case for points P1, P2. Accordingly, undesired rattling or other unwanted noise can be suppressed or at least can be reduced.

In this context, FIGS. 8 and 9 show the result of an exemplary tuning process, i.e. exemplary graphs of the phase shift φ and gains G of the second signal ACS over the frequency f for the points P1 . . . P3. As can be seen, tuning the sound system 1 to a reduced movement of different points P1 . . . P3 leads to different graphs. As a consequence, usually a tradeoff has to be made if a movement of more points P1 . . . P3 shall considerably be reduced.

In this context, in an alternative embodiment, the signal influencing circuit 17, 17a . . . 17d in an operating setting can be set in a way that, in at least a part of the frequency range of the sound system 1, a) a maximum amplitude or b) an average amplitude of a mechanical oscillation of the housing and/or frame 23 of the electronic device 22c in case a) is below 50% of a maximum amplitude or in case b) is below 50% of an average amplitude of a mechanical oscillation of the housing and/or frame 23 in a reference setting where the actuator 8 is switched off.

Here, the sound system 1 or its signal influencing circuit 17, 17a . . . 17d respectively is tuned in a way that a vibration of the whole housing and/or frame 23 of the electronic device 22c is substantially reduced. Tuning can be done in a way that a maximum amplitude of the housing and/or frame 23 is substantially reduced (case a) or that an average amplitude of a mechanical oscillation of the housing and/or frame 23 is substantially reduced (case b).

It should be noted in this context that the point P1 . . . P3, at which the maximum amplitude is measured in the operating setting, is not necessarily the point P1 . . . P3, at which the maximum amplitude is measured in the reference setting. Instead, the points P1 . . . P3, at which the maximum amplitude occurs in both settings, may differ from one another. It should also be noted that the graphs of FIGS. 8 and 9 are exemplary and only shall illustrate possible tuning results. However, the graphs may considerably differ from the one shown in FIGS. 8 and 9 under different conditions.

Preferably the aforementioned conditions are true in a steady state of the sound system 1, i.e. in a steady state of oscillations of the speaker 2 and the actuator 8. Moreover, the above conditions particularly are true for harmonic or sinusoidal sound signals AUD at the audio input I1. For example, a mechanical oscillation of the housing and/or frame 23 can be measured with a laser during a tuning procedure.

Generally, the frequency range of the sound system 1, 1a . . . If can reach from 20 Hz to 20 kHz. In this way, the frequency range of sound audible by humans is covered.

FIG. 10 now shows a cross sectional view of an arrangement of a speaker 2 and an actuator 8 built into a housing 23. In this embodiment, there is an angle a between the first axis A1, A1′ and the second axis A2 what may save space under certain conditions. However, to obtain a satisfying vibration compensation, the angle a between the first axis A1, A1′ and the second axis A2 should be in a range of 0°≤α≤45°

To obtain a satisfying vibration compensation, moreover, it is useful if the coupling means 16, 23, 26 for mechanically coupling the actuator 8 to the speaker 2 are formed by an elastic element with a natural resonance>1 kHz. The proposed frequency range provides sufficient coupling between the actuator 8 and the speaker 2 for housings and/or frames 23 of common electronic devices 22a . . . 22c, which housings and/or frames 23 or elements thereof basically rattle above said frequency f without vibration compensation.

It is also of advantage, if the phase shift φ fulfills the conditions 10°<φ<170° and 190°<φ<350° in at least a part of the frequency range of the sound system 1, 1a . . . 1f. In this way, the advantages of the proposed sound system 1, 1a . . . If are even more pronounced.

Finally it is noted that the scope of the present invention is defined by the appended claims, including known equivalents and unforeseeable equivalents at the time of filing of this application. Although numerous embodiments of this invention have been described above with a certain degree of particularity, those skilled in the art could make numerous alterations to the disclosed embodiments without departing from the spirit or scope of this disclosure.

### LIST OF REFERENCES

1, 1a . . . 1f sound system
2 speaker
3 membrane
4 speaker voice coil
5a speaker magnet
5b speaker pot
5c speaker top plate
6 speaker motor
7 speaker housing/speaker frame
8 actuator
9a, 9b actuator voice coil
10 outer actuator ring
11a actuator magnet
11b actuator bottom plate
11c actuator top plate
12 moving mass
13 actuator motor
14 spring
15 actuator housing/actuator frame
16 coupling means
17, 17a . . . 17d signal influencing circuit
18 phase shifter/allpass filter
19 matching filter
20 speaker amplifier/speaker driver stage
21 actuator amplifier/actuator driver stage
22a . . . 22c electronic device
23 housing or frame of electronic device
24 display of electronic device
25 sound port
26 common speaker and actuator housing or frame
27 air connection
28 non-linear actuator model
29 actuator model amplifier
30 summing unit
31 actuator resistance detector
32 non-linear speaker model
33 speaker resistance detector
34 movement difference detector
35 power saving control
36 power saving switch
37a . . . 37d button
α angle between first and second axis
A1, A1′ first axis
A2 second axis
BV back volume
SES sound emanating surface
P1 . . . P3 point of the housing/frame
I1 audio input
I2 first actuator model input
I3 second actuator model input
I4 actuator resistance detector input
I5 first speaker model input
I6 second speaker model input
I7 speaker resistance detector input
I8 first input of movement difference detector
I9 second input of movement difference detector
I10 supply voltage or switch off signal input
O1 speaker output
O2 actuator output
O3 (first) actuator model output
O4 actuator resistance detector output
O5 speaker model output
O6 speaker resistance detector output
O7 second actuator model output
O8 output of movement difference detector
O9 first power saving switching output
O10 second power saving switching output
SP1 first signal path
SP2 second signal path
AUD audio signal
SPS first electric signal
ACS second electric signal
VCC supply voltage or switch off signal
f frequency
φ phase shift
G amplification/gain

What is claimed is:

1. A Sound system (1, 1a . . . 1f), comprising:
a speaker (2), having a membrane (3) and a speaker motor (6) coupled thereto, wherein the speaker motor (6) is designed for moving the membrane (3) along a first axis (A1, A1′);
an actuator (8) having a moving mass (12) and an actuator motor (13) coupled thereto, wherein the actuator motor (13) is designed for moving the moving mass (12) along a second axis (A2) and wherein the second axis (A2) is displaced from the first axis (A1, A1′); and
coupling means (16), for mechanically coupling the actuator (8) to the speaker (2),
wherein the sound system (1, 1a . . . 1f) further comprises a signal influencing circuit (17, 17a . . . 17d),
which has an audio input (I1), a speaker output (O1), an actuator output (O2), a first signal path (SP1) from the audio input (I1) to the speaker output (O1) and a second signal path (SP2) from the audio input (I1) to the actuator output (O2),
which is designed to feed a first electric signal (SPS) to the speaker motor (6) via the speaker output (O1) and a second electric signal (ACS) to the actuator motor (13) via the actuator output (O2) based on an audio signal (AUD) received at the audio input (I1), and
which is designed to vary an amplification (G) of the second electric signal (ACS) over a frequency range of the sound system (1, 1a . . . 1f) and/or to set a phase shift (φ) between the first electric signal (SPS) and the second electric signal (ACS), which phase shift (φ) is non-equal to 0° and 180° in at least a part of the frequency range of the sound system (1, 1a . . . 1f).

2. The sound system (1, 1a . . . 1f) as claimed in claim 1, wherein the phase shift (φ) fulfills the conditions 10°<φ<170° and 190°<φ<350°.

3. The sound system (1, 1a . . . 1f) as claimed in claim 1, wherein the signal influencing circuit (17, 17a . . . 17d) comprises a matching filter (19) in the second signal path (SP2).

4. The sound system (1, 1a . . . 1f) as claimed in claim 1, wherein the signal influencing circuit (17, 17a . . . 17d) comprises:
a phase shifter or an allpass filter (18) respectively in the first signal path (SP1); and
a matching filter (19) with a complex transfer function in the second signal path (SP2).

5. The sound system (1, 1a . . . 1f) as claimed in claim 4, wherein the signal influencing circuit (17, 17a . . . 17d) additionally comprises a non-linear actuator model (28) of the actuator (8) and an actuator resistance detector (31) for detecting a DC resistance of the actuator (8),
wherein the actuator model (28) has a first actuator model input (I2) being connected to an input path leading to the matching filter (19), a second actuator model input (I3) being connected to an output (O4) of the actuator resistance detector (31) and an output (O3), which is coupled to the second signal path (SP2) before the input path to the matching filter (19).

6. The sound system (1, 1a . . . 1f) as claimed in claim 4, wherein the signal influencing circuit (17, 17a . . . 17d) additionally comprises a non-linear speaker model (32) of the speaker (2), a speaker resistance detector (33) for detecting a DC resistance of the speaker (2) and a movement difference detector (34) for detecting a difference between a speaker movement parameter and an actuator movement parameter,
wherein the speaker model (32) has a first speaker model input (I5) being connected to an input path leading to the phase shifter or allpass filter (18) and a second speaker model input (I6) being connected to an output (O6) of the speaker resistance detector (33), and
wherein the movement difference detector (34) has a first input (I8), which is connected to an output (O5) of the speaker model (32), a second input (I9), which is connected to an output (O7) of the actuator model (28), and an output (O8), which is coupled to the second signal path (SP2) before the input path to the matching filter (19).

7. The sound system (1, 1a . . . 1f) as claimed in claim 1, wherein said frequency range reaches from 20 Hz to 20 kHz.

8. The sound system (1, 1a . . . 1f) as claimed in claim 1, wherein a ratio between a moving mass of the speaker (2) and the moving mass (12) of the actuator (8) is in a range of 0.5 to 5.

9. The sound system (1, 1a . . . 1f) as claimed in claim 1, wherein an angle (α) between the first axis (A1, A1′) and the second axis (A2) is in a range of 0°≤α≤45°.

10. The sound system (1, 1a . . . 1f) as claimed in claim 1, wherein the actuator motor (13) is not designed for moving a membrane (3) along the second axis (A2).

11. The sound system (1, 1a . . . 1f) as claimed in claim 1, wherein
an average sound pressure level of the speaker (2) measured in an orthogonal distance of 10 cm from a sound emanating surface (SES) of the membrane (3) is at least 50 dB_SPL, and
an average sound pressure level of the actuator (8) measured at the same directional distance is at most 20 dB_SPL in the same frequency range.

12. The sound system (1, 1a . . . 1f) as claimed in claim 1, wherein the speaker (2) comprises a back volume (BV) and wherein the actuator (8) is arranged out of or inside said back volume (BV).

13. The sound system (1, 1a . . . 1f) as claimed in claim 1, additionally comprising an input (I10) for a supply voltage or a switch off signal (VCC) and a power saving control (35), which is designed for reducing an amplitude of the second electric signal (ACS) compared to a normal operating setting or for turning off generation of the second electric signal (ACS) below a threshold value of the supply voltage (VCC) or in case that the switch off signal (VCC) is received.

14. The sound system (1, 1a . . . 1f) as claimed in claim 1, wherein the coupling means (16) for mechanically coupling the actuator (8) to the speaker (2) are formed by an elastic element with a natural resonance >1 kHz.

15. An electronic device (22a . . . 22c), comprising a sound system (1, 1a . . . 1f) as claimed in claim 1 built into a housing and/or to a frame (23) of the electronic device (22a . . . 22c), wherein the coupling means (16) for mechanically coupling the actuator (8) to the speaker (2) are formed at least partially by said housing and/or frame (23).

16. The electronic device (22a . . . 22c) as claimed in claim 15, wherein the signal influencing circuit (17, 17a . . . 17d) in an operating setting is set in a way that, in at least a part of the frequency range of the sound system (1, 1a . . . 1f), an amplitude of a mechanical oscillation at a particular point (P1 . . . P3) of the housing and/or frame (23) of the electronic device (22a . . . 22c) is below 50% of an amplitude of a mechanical oscillation at said particular point (P1 . . . P3) of the housing and/or frame (23) in a reference setting where the actuator (8) is switched off.

17. The electronic device (22a . . . 22c) as claimed in claim 15, wherein the signal influencing circuit (17, 17a . . . 17d) in an operating setting is set in a way that, in at least a part of the frequency range of the sound system (1, 1a . . . 1f), a) a maximum amplitude or b) an average amplitude of a mechanical oscillation of the housing and/or frame (23) of the electronic device (22a . . . 22c) in case a) is below 50% of a maximum amplitude or in case b) is below 50% of an average amplitude of a mechanical oscillation of the housing and/or frame (23) in a reference setting where the actuator (8) is switched off.
